(19) United States
(12) Patent Application Publication
(10) Pub. No.: US 2010/0332242 A1
(43) Pub. Date: Dec. 30, 2010

(54) COLLABORATIVE PLAN GENERATION BASED ON VARYING PREFERENCES AND CONSTRAINTS

(75) Inventors: Ece Kamar, Cambridge, MA (US); Eric J. Horvitz, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/491,635

(22) Filed: Jun. 25, 2009

(51) Int. Cl. G06Q 99/00

(52) U.S. Cl. 705/1.1

(57) ABSTRACT

Embodiments for generating and implementing collaborative plans that achieve goals for sets of individual agents based on a consideration of individual and group preferences are disclosed. In accordance with at least one embodiment, a collaborative mechanism includes receiving individual plan preferences of agents via one or more client devices and modeling agent costs based on the received individual plan preferences. One or more collaborative plans are then be generated based on the modeled agent costs and one or more agents may be grouped into each collaborative plan. The one or more generated collaborative plans are provided to the agents via the one or more client devices for implementation. Finally, payments are distributed among the agents to compensate at least one agent for participation in one of the generated collaborative plans.

### BACKGROUND

The use of carbon-based fuel for transportation accounts from a large percentage of the CO₂ that are released into the atmosphere every year. Ridesharing has been proposed as a promising means for reducing CO₂ emissions and fuel expenditures. Making use of unused seats in cars may deliver personal savings as well as global environmental benefits in the form of reduced pollution emissions. However, participants in a carpool can incur costs associated with ridesharing. For example, such costs may include increased fuel and time costs due to the lengthening of a commute to accommodate new waypoints, and/or the shifting of the departure and arrival times to match the needs of others.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments for creating an agent-based carpooling mechanism that creates personalized rideshare plans while reducing the cumulative cost of transportation. However, it will be appreciated that the optimization and optimization mechanisms described herein in the context of the agent-based carpooling may be generally applied for any situation that calls for the generation of collaborative plans for sets of individual contributors, or agents, with individual goals and preferences, and who might otherwise execute plans as individuals. Thus, the embodiments of the agent-based carpooling mechanism described herein are intended to be non-limiting embodiments.

In the various embodiments of the agent-based mechanism, the agent-based mechanism may employ a Vickrey-Clarke-Groves (VCG)-based payment scheme to provide fair and efficient solutions for collaborative ridesharing. The agent-based mechanism may divide the cost of service among self-interested agents in a fair manner, by which the cost may depend on agent preferences. Accordingly, the agent-based mechanism may adapt to varied and dynamic preferences of self-interested agents and provide compelling and fair incentives. Thus, the agent-based mechanism may provide efficient solutions for collaborative ridesharing that create personalized ridesharing plans while minimizing the cumulative cost of transportation.

In at least one embodiment, a collaborative mechanism includes receiving individual plan preferences of agents via one or more client devices and modeling agent costs based on the received individual plan preferences. One or more collaborative plans are then be generated based on the modeled agent costs and one or more agents may be grouped into each collaborative plan. The one or more generated collaborative plans are provided to the agents via the one or more client devices for implementation. Finally, payments are distributed among the agents to compensate at least one agent for participation in one of the generated collaborative plans.

Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 illustrates an exemplary system for implementing an agent-based carpooling (ABC) system that employs a Vickrey-Clarke-Groves (VCG)-based payment mechanism, in accordance with various embodiments.

FIG. 2 illustrates exemplary collaborative rideshare plans, as developed by the ABC system 100, in accordance with various embodiments

FIG. 3 illustrates a block diagram that shows selected components of one example of computing device 102 that implements and agent-based carpooling (ABC) system that employs a Vickrey-Clarke-Groves (VCG)-based payment mechanism, in accordance with various embodiments.

FIG. 4 illustrates exemplary carpool information that is presented on a display of an exemplary client device, in accordance with various embodiments.

FIG. 5 illustrates a flow diagram showing an exemplary process that facilitates an agent-based carpooling (ABC) system that employs a Vickrey-Clarke-Groves (VCG)-based payment mechanism, in accordance with various embodiments.

FIG. 6 illustrates a representative computing device that is used to implement techniques and mechanisms for agent-based carpooling that employs a Vickrey-Clarke-Groves (VCG)-based payment mechanism, in accordance with various embodiments.

### DETAILED DESCRIPTION

This disclosure is directed to an agent-based carpooling mechanism that creates personalized rideshare plans while reducing the cumulative cost of transportation. In the various embodiments described herein, the agent-based mechanism may employ a Vickrey-Clarke-Groves (VCG)-based payment mechanism to provide fair and efficient solutions for collaborative ridesharing. The agent-based mechanism may divide the cost of service among self-interested agents in a fair manner, by which the cost may depend on agent preferences. Accordingly, the agent-based mechanism may adapt to varied and dynamic preferences of self-interested agents and provide compelling and fair incentives.

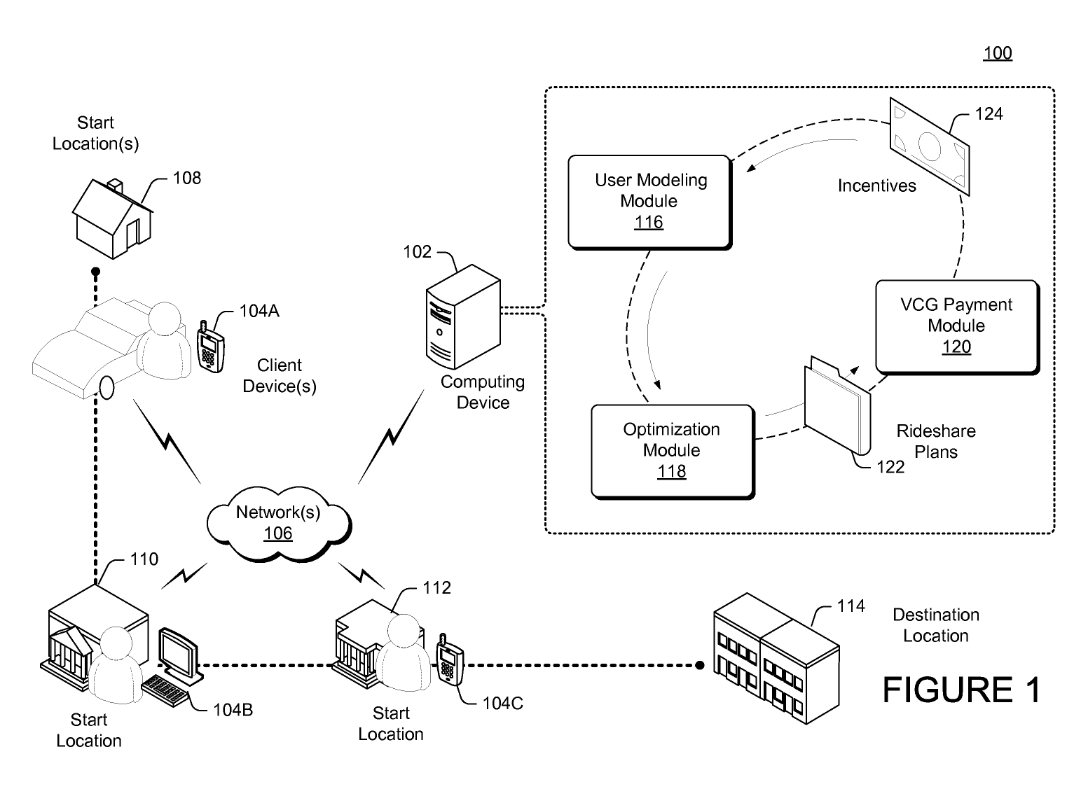

Thus, the agent-based mechanism may provide efficient solutions for collaborative ridesharing that creates personalized ridesharing plans while reducing the cumulative cost of transportation. Various examples of the agent-based carpooling mechanism that creates personalized rideshare plans while minimizing the cumulative cost of transportation in accordance with the embodiments are described below with reference to FIGS. 1-6.

### Exemplary Scheme

FIG. 1 illustrates an exemplary agent-based carpooling (ABC) system 100 that employs Vickrey-Clarke-Groves (VCG)-based payments, in accordance with various embodiments. The system 100 may enable participants, or agents, to set up rideshares (carpools), thereby making use of unused seats in vehicles to reduce CO₂ emissions, reduce fuel consumption, relieve traffic congestion, as well as produce other environmental benefits.

With the use of a VCG-based payment mechanism, the system 100 may compensate rideshare agents for the incurred costs associated with carpooling. These incurred costs may include increased fuel and time costs associated with lengthening of a commute that contains new waypoints, and/or shifting of the departure and arrival times to accommodate the needs of other car pool participants. Accordingly, the system 100 may provide fair and efficient rideshare solutions while respecting the privacy of the agents, and promote truthful behavior on the part of the agents.

The system 100 may include a computing device 102 and one or more client devices 104(A-C). It will be appreciated that the client devices 104(A-C) are presented for illustrative purposes and not as a limitation, and that the actual number of client devices may vary in different embodiments. The computing device 102 and the client devices 104(A-C) may be connected via one or more networks 106.

Each of the client devices 104(A-C) may be any computing device that has network access capabilities, e.g., a desktop computer, a laptop computer, a tablet computer, smart phone, personal digital assistants (PDAs), and other wireless communication devices. The one or more networks 106 are representative of any one or combination of different types of networks, such as cable networks, the Internet, and wireless telephone networks. The one or more networks 106 may enable client devices, such as client devices 104(A-C), to communicate with the computing device 102.

In operation, the system 100 may enable an agent to send preference data, such as, but not limited to, one of the trip start locations 108-112, a trip destination location 114, intended times of travel, etc., to the computing device 102 via one of the client devices 104(A-C), as well as receive data from the computing device 102. The received data may include instructions to participate in a specific carpool (e.g., carpool pickup location, carpool date and time, description of carpool vehicle, etc.).

The computing device 102 may include software applications components such as a user modeling module 116, an optimization module 118, and a VCG payment module 120. The user modeling module 116 may access and model the preferences of agents, the optimization module 118 may generate rideshare plans 122, and the VCG payment module 120 may provide incentives to the agents for their collaboration in the rideshare plans.

Specifically, the user modeling module 116 may dynamically gather information about commute plans of the agents, including their origin, destination, timing of a trip, and preferences about a return trip. The user modeling module 116 may receive the commute information from the client devices 104(A-C). To facilitate further cost-benefit analysis by the optimization module 118, the user modeling module 116 may model agent-specific costs for driving, delaying a trip, diverting an ideal route to pick up or drop off other agents, and changing stop points and preferences about social considerations.

Based on the information provided by the user modeling module 116, the optimization module 118 may generate a collection of collaborative rideshare plans 122 that maximize the efficiency of transportation. In other words, the optimization module 118 may perform dynamic cost-benefit analysis on a set of individually desired commute plans to minimize the total cost of transportation and generate one or more collaborative rideshare plans 122. In some embodiments, the optimization module 118 may further perform dynamic cost-benefit analysis on a set of individually desired commute plans and generate one or more collaborative rideshare plans 122 that enable agents to carpool with a minimal number of vehicles utilized and miles traveled. The one or more collaborative rideshare plans 122 may be created dynamically in real time to enable the agents to carpool. The computing device 102 may transmit the one or more collaborative rideshare plans 122 back to the agents via the client devices 104(A-C).

The VCG payment module 120 may distribute VCG-based payments to promote truthful behavior, to ensure fairness and the sustainability of the rideshare system, and to maximize the total value of the collaboration among the agents. In other words, the VCG payment module 120 may make the ABC system as efficient, budget-balanced, and individually rational as possible. For example, the VCG-payment module 120 may shift payment, or incentives 124, from those agents (e.g., passengers) that benefited from participation in the ABC system to those agents (e.g., drivers) that incurred costs due to participation in the ABC system. In various embodiments, the benefited agents may pay incentives 124 (e.g., money) into the system 100, and the system 100 may distribute the incentives 124 to compensate agents that incurred cost through participation.

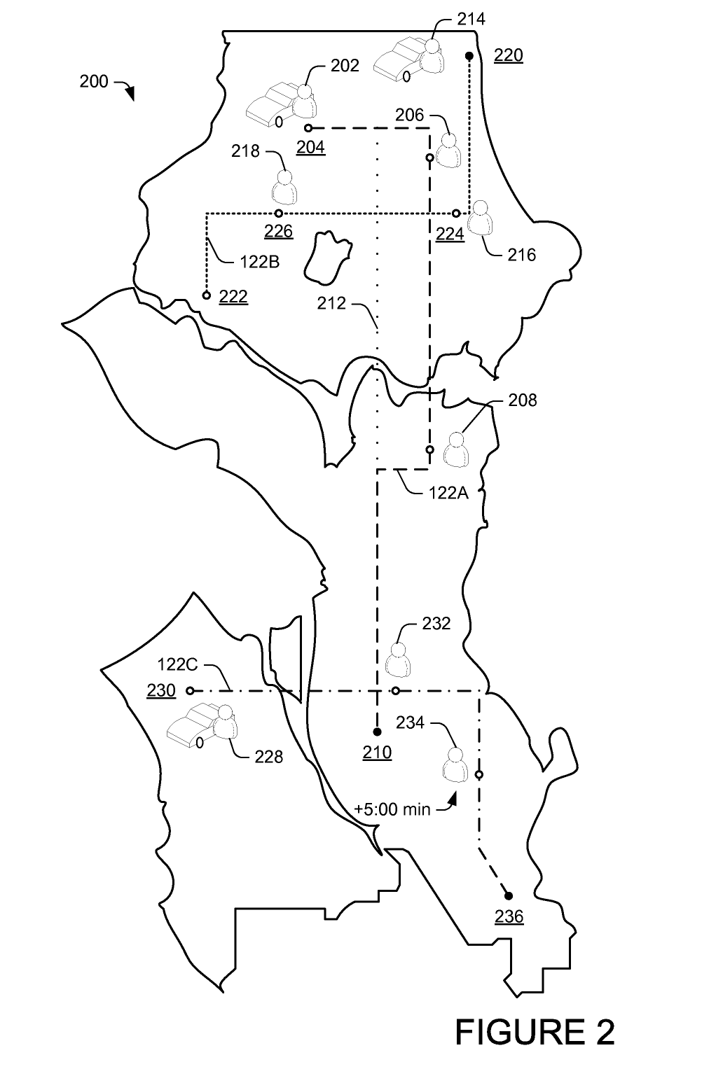

FIG. 2 illustrates exemplary collaborative rideshare plans 122, as developed by the ABC system 100 (FIG. 1), in accordance with various embodiments. The collaborative rideshare plans 122 are illustrated in the context of an exemplary geographical map 200. It will be appreciated that FIG. 2 is intended to be illustrative rather than limiting, and the actual number and routes of the rideshare plans 122 may vary in different embodiments. As shown, the exemplary rideshare plans 122 may include a ride share plan 122A, a rideshare plan 122B, and a rideshare plan 122C.

Rideshare plan 122A may enable a driver agent 202, who initiates a car trip from a start location 204 to rideshare with passenger agents 206 and 208 to commute to destination location 210. In various embodiments, the driver agent 202 may be routed to pick up the passenger agents 206 and 208 based on the commute plans (e.g., origin, destination, timing of trip, etc.) of each agent. As further described below, the ABC system 100 (FIG. 1) may implement one or more collaborative rideshare plans 122 by modifying one or more individual commute plans of the agents participating in the plans. For example, but not as a limitation, in the implementation of the rideshare plan 122A, the ABC system 100 may cause the driver agent 202 to partially deviate from an original commute route 212 to pick up passenger agents 206 and 208.

In another non-limiting example, the ABC system 100 may provide a rideshare plan 122B that enables a driver agent 214 to pick up passenger agents 216 and 218 at a common start location 220 when making a trip to the destination location 222. However, the rideshare plan 122B may necessitate that the driver agent 214 stop at additional stop points 224 and 226, respectively, to drop off passenger agents 216 and 218.

Likewise, in an additional non-limiting example, the ABC system 100 may provide a rideshare plan 122C that enables a driver agent 228, who initiates a car trip from start location 230 to rideshare with passenger agents 232 and 234 to commute to destination location 236. However, the rideshare plan 122C may call for the passenger 234 to delay his/her trip start time by a predetermined amount of time (e.g., five minutes) to enable passenger agent 234 to rideshare with the driver agent 226. Alternatively, the rideshare plan 122C may cause the driver agent 228 to revise his start time to accommodate the intended trip start time of the passenger 234.

It will be appreciated that the ABC system 100 may process and develop a plurality of collaborative rideshare plans 122 simultaneously and in real time to accommodate the commute plans of different agents. For example, as described above, the ABC system 100 may enable one or more agents to communicate their commute plans to the ABC system 100 via client devices, such as the client devices 104(A-C), so that the ABC system 100 may create updates or additions to the rideshare plans 122. Moreover, while the ABC system 100 is illustrated in FIG. 2 as developing rideshare plans 122 that enable multiple agents to travel to a single destination from multiple start locations, the ABC system 100, as further described below, may also develop rideshare plans that enable agents to travel to multiple destinations from multiple start locations.

### Exemplary Components

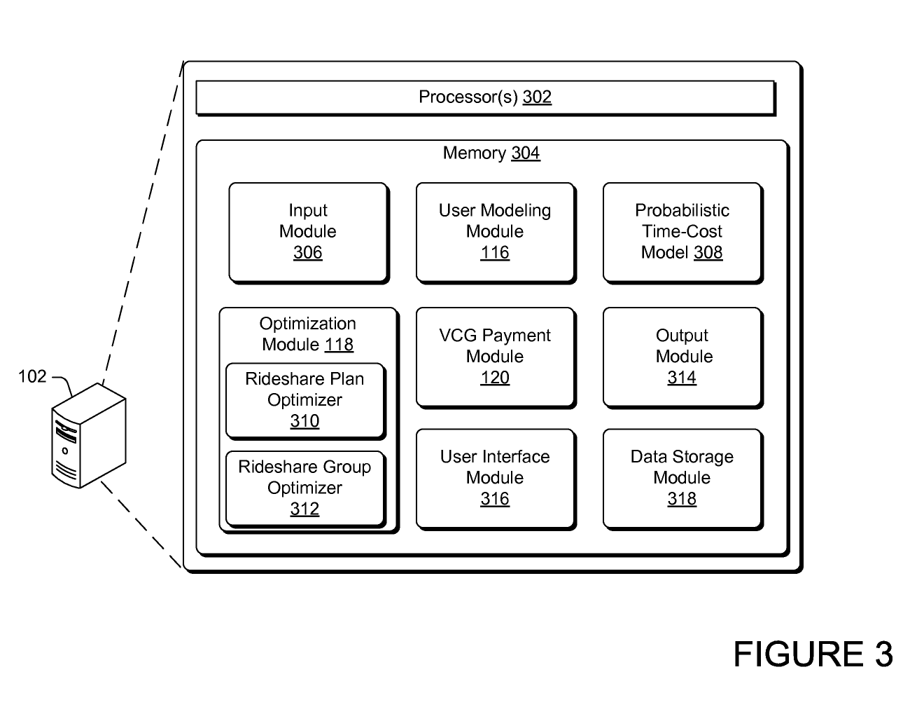

FIG. 3 illustrates selected components of one exemplary computer device 102 that creates personalized rideshare plans while reducing the cumulative cost of transportation, in accordance with various embodiments. The computing device 102 may include one or more processors 302 and memory 304. The memory 304 may include volatile and/or nonvolatile memory, removable and/or non-removable media implemented in any method or technology for storage of information, such as computer-readable instructions, data structures, program modules or other data. Such memory may include, but is not limited to, random accessory memory (RAM), read-only memory (ROM), electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system.

The memory 304 may store program instructions. The program instructions, or modules, may include routines, programs, objects, components, and data structures that cause components of computer 102 to perform particular tasks or implement particular abstract data types. The selected program instructions may include a user modeling module 116, an optimization module 118, and a VCG payment module 120. The optimization module 118 may further include a rideshare plan optimizer 310, and a rideshare group optimizer 312. The selected program instructions may further include an input module 306, a probabilistic time-cost model 308, an output module 314, a user interface module 316, and a data storage module 318.

The input module 306 may interface with one or more of the client devices 104(A-C) to gather preferences of the agents. In some embodiments, the input module 306 may gather the preferences via a web page that is accessible to the agents via the client devices 104(A-C). In other embodiments, the input module 306 may be configured to extract agent preferences from data messages (e.g., SMS messages) that are received from the client devices 104(A-C). The agent preferences may include information such as agent identification, origin location, destination location, time of trip, and preferences about a return trip, etc. The input module 306 may store the agent preference data in the data storage module 318.

The user modeling module 116 may identify the preferences of agents about their desired trips, and for passing the preferences into the optimization module 118 and the VCG payment module 120. The user modeling module 116 may use the input module 306 to gather information about commute plans of the agents, including their identification, origin location, destination location, timing of a trip, and preferences about a return trip. In some embodiments, the user modeling module 116 may employ a destination analyzer to access or guess the intended destination of one or more agents.

In order to enable the performance of a cost-benefit analysis of a ridesharing plan, the user modeling module 116 may model agent-specific costs for driving, delaying a trip, diverting an ideal route to pick up or drop off other agents, and changing stop points. In various embodiments, the user modeling module 116 may capture these costs in a dynamic manner, as the ABC system 100 needs to adapt to different and changing preferences of agents.

Time is an important resource and may be one of the major factors influencing the cost of different commute plans. For example, an agent may be willing to wait and pick up other agents on the way when the cost of time is low, but not on a day when time cost is high. In various embodiments, the user modeling module 116 may employ a probabilistic time-cost model 308.

The model 308 may consider inputs such as, but not limited to, the time of day, day of week, and/or sets of attributes about agents' commitments drawn from an online appointment book. The probabilistic portion of the model 308 that accounts for the cost of time may be learned from user annotated training data via a machine-learning procedure based on Bayesian structure search.

Accordingly, for the current state of each of the agents, the user modeling module 116 may construct a time-cost function T to estimate the cost of the time spent travelling between the start time (tₛ) and end time (tₑ) of the trip, and the additional cost for delaying the start time of a rideshare trip from the initial start time tₛ^{o} to tₛ. In at least one embodiment, T may be captured with respect to the nearest deadlines drawn from the agent's calendar. For example, but not as limitation, given a set of calendar items that fall between [tₛ, tₑ] is M, where m ∈ M is a calendar item, the start time of m may be represented as tₛ^{m}, the end time of m may be represented as tₑ^{m}, cₙ may represent the minute time cost for travelling, cₘ may represent the additional cost for missing a minute of m, and c_{d} may represent the minute cost for delay, T may be defined as:

$$T ( {t}_{s} , {t}_{e} ) = ( ( {t}_{e} - {t}_{s} ) \times {c}_{n} ) + ( \vert {t}_{s} - {t}_{s}^{o} \vert \times {c}_{d} ) + ( {\sum }_{m ∈ M} ( min ( {t}_{e}^{m} , {t}_{e} ) - max ( {t}_{s}^{m} , {t}_{s} ) ) \times {c}_{m} ) \qquad ( 1 )$$

The optimization module 118 may be employed to group agents together and generate a collection of rideshare plans that increase the efficiency of the ABC system. The optimization module 118 may acquire user preferences from the user modeling module 116 and combine them with global contexts to capture the collaborative value of a rideshare plan. The optimization module 118 may combine multiple user preferences and contextual factors to determine the best possible plan. Accordingly, agents do not need to know about the preferences of other agents, nor do agents need to know the details of rideshare plans that they are not involved in. In various embodiments, the optimization component 118 may take in a set of individual desired commute plans as inputs and perform optimization to generate one or more collaborative rideshare plans 122. In at least one embodiment, the optimizations may include clustering agents into rideshare groups and generating rideshare plans for groups of agents.

In various embodiments, the optimization module 118 may analyze the possible trip start times of the agents, stop orders of the agents, stop locations of the agents, trip durations, and possible routes among stop points to generate plans with highest possible cumulative value for the overall ABC system. For example, in at least one embodiment, P may represent all agents in ABC system, S ⊂ P may represent a rideshare group, C(S) may represent the universe of all possible rideshare plans for S. Moreover, a rideshare plan Cᵢ ∈ C(S) may be defined by the following attributes:

S={Ph, . . . ,Pq} may represent the set of agents of the rideshare group; P_{d} ∈ C(S), the assigned driver for the rideshare plan; S_{-d}=S\{P_{d}}.

L_{-d}={l_{h,s},l_{h,e}, . . . ,l_{q,s},l_{q,e}} may represent the set of start/end (stop) locations of agents in S_{-d}, where pᵢ's start location is l_{i,s}, the end location is l_{i,e}. For all pᵢ ∈ S_{-d}, l_{i,s} and l_{i,e} are located in a radius of l_{i,s}^{o} and l_{i,e}^{o}—the initial start/end locations for pᵢ's individual commute plan., L, the complete set of start/end locations, is the combination of L_{-d} with the start/end locations of P_{d}: L=L_{-d} ∪{l_{d,s},l_{d,e}}, where l_{d,s}=l_{d,s}^{o},l_{d,e}=l_{d,e}^{o}.

Θ_{-d}, the commute chain excluding P_{d}, may represent any ordering of L_{-d} such that for all pᵢ ∈ S_{-d}, index(l_{i,s})<index(l_{i,e}) (i.e., any agent's start location precedes the end location in Θ_{-d}. Θ=l_{d,s}·Q_{-d}·l_{d,e} is the commute chain for S.

Further, tₛ may represent start time of the rideshare plan. t(l), the scheduled time of stop location l may be defined as below, where Δt(lⱼ,lⱼ₊₁) may represent the estimated travel duration between two consecutive stop locations lⱼ,lⱼ₊₁ ∈ Θ:

$$t ( 𝓁 ) = \{ \begin{matrix}{t}_{s} , & l = {𝓁}_{d , s} \\ {t}_{s} + {\sum }_{{𝓁}_{j} , {𝓁}_{j + 1} : j < index ( 𝓁 )} Δ t ( {𝓁}_{j} , {𝓁}_{j + 1} ) , & otherwise\end{matrix} \qquad ( 2 )$$

Although the reduction in gas costs and personal goals of reducing CO₂ emissions from vehicles may act as motivation for bringing self-interested agents to collaborate in rideshare plans, the additional time and travel required for adding new stops to a trip, or having fewer numbers of agents driving in heavy traffic may also affect the willingness of agents to participate. Accordingly, the optimization module 118 may also take into account personal inconvenience cost when generating a plan with highest possible cumulative value for the overall ABC system. The personal inconvenience cost may include several agent-specific cost factors. In some embodiments, the optimization module 118 may implement a model for the cost of personal inconvenience that combines the time cost with gas and cognitive costs to estimate the cost of an agent becoming associated with a trip.

The optimization module 118 may use such an inconvenience model to combine the input from the modeling component 116 with traffic predictive services and daily contexts (e.g., daily events and conditions that may affect traffic) to construct a cognitive cost model for each agent. The inconvenience model may be based on the probabilistic time-cost function Tᵢ(tₛ,tₑ) provided by the user modeling component 116. Additionally, the fuel cost in dollars for one mile may be represented as C_{g} in the inconvenience model.

Accordingly, in the implementation of the inconvenience model, CCᵢ(lₛ,lₑ) may represent the predicted cognitive cost of an agent pᵢ for driving between given stops. The optimization module 118 may make calls to a traffic predictive service (e.g., Microsoft MapPoint services provided by Microsoft Corporation of Redmond, Wash.) to estimate travel duration between the given stops. Thus, Δt(lᵢ,lⱼ) may represents the duration of travel between stops lᵢ and lⱼ, whereas Δd(lᵢ,lⱼ) may represent the distance to be travelled between these stops.

With respect to the initial personal inconvenience cost for an agent pᵢ, PC^{o}(pᵢ) may represent the cost for pᵢ following the individual trip that would be created between initial start/end locations of pᵢ in the absence of ridesharing, in which the start time of the individual trip is t_{i,s}^{o}. Thus, PC^{o}(pᵢ) may be expressed as:

PC^{o}(pᵢ)=Tᵢ(t_{i,s}^{o},t_{i,e}^{o})+Δd(l_{i,s}^{o},l_{i,e}^{o})×C_{g}+CCᵢ(l_{i,s}^{o},l_{i,e}^{o}) (3)

Further, t_{i,e}^{o} may be expressed as:

t_{i,e}^{o}=t_{i,s}^{o}+Δt(l_{i,s}^{o},l_{i,e}^{o}) (4)

A gas and cognitive cost is incurred if an agent is assigned as the driver in a given trip. Therefore, in the inconvenience model, lᵢ, lⱼ₊₁ ∈ L may represent consecutive stop locations in commute chain Θ. PC(p_{d},C) may be the personal inconvenience cost of the driver for rideshare plan C. Thus, PC(p_{d},C) may be expressed as:

PC(p_{d},C)=T_{d}(t(l_{d,s}),t(l_{d,e}))+Σₗ_{_{j,}}ₗ_{ⱼ₊₁}(Δd(lⱼ,lⱼ₊₁)×c_{g}+CC_{d}(lⱼ,lⱼ₊₁)) (5)

The passenger agents of a rideshare are only subject to time costs for the duration between their scheduled start and end locations. Thus, PC(pᵢ,C) may represent the personal inconvenience cost of a passenger agent pᵢ ∈ S_{-d} for rideshare plan C, as follows:

PC(pᵢ,C)=Tᵢ(t(l_{i,s}),t(l_{i,e})) (6)

Moreover, vᵢ may represent the value of agent pᵢ for rideshare plan C. The value of a rideshare plan, V(C), may represent the value of agents in rideshare plan C for switching to collaborative plan C from their individual plans, as follows:

vᵢ(C)=PC^{o}(pᵢ)−PC(pᵢ,C) (7)

V(C)=(Σₚ_{ᵢ}_{∈S} vᵢ(C)) (8)

The optimization module 118 may further taken in to account subtle, yet potentially powerful psychological and social costs, as well as benefits that driver agents and passenger agents of the ABC system 100 may derive from sharing rides with others in the open world. Accordingly, the optimization module 118 may assess and integrate key psychosocial factors as additional costs into the optimization used for generating rideshare plans. For instance, carpool participants can be offered the option of providing preference functions that yield estimates of the cost of traveling with one or more agents based on established reputations, and/or on social or organizational relationships.

As examples, preferences can be captured with utility functions that specify the costs associated with including agents in a shared plan that are related to the participant via different types of organizational links or via increasing graph distances in a social network. Such additional costs would likely influence individual objective functions, and thus the overall behavior of the ABC system 100, leading to modifications in the rideshare plans generated as compared to the outputs of an ABC system that does not consider the psychosocial issues.

Thus, the personal inconvenience cost function described above, or PC, which represents the basic cost of a carpool agent for a given carpool plan, may be extended to account for agents' more comprehensive preferences, such as social factors.

In various embodiments, let EC(p,C) be the extended cost function that includes and enriches the personal cost function PC(p,C) for agent p and carpool plan C with considerations for social factors. To represent the constraints and preferences of an agent p for social factors, a social cost function, SC(p,C), may be defined. Accordingly, the extended cost function EC(p,C) may combine basic personal inconvenience costs with social costs as follows:

EC(p,C)=PC(p,C)+SC(p,C) (9)

The extended cost function may replace the personal inconvenience cost function in value calculations (Equation 7) to account for considerations regarding social factors. In this way, the general optimization algorithm of the carpool mechanism may enable the smooth insertion of complex constraints and preferences, without requiring changes on the optimization and payment components.

Moreover, the social cost function may be represented as a distance function (d) that takes multiple attributes of the carpool plan as inputs. The distance function may be an arbitrary function that represents the relationships between independent or interdependent attributes of agents pₕ, . . . , p_{q}, involved in the carpool plan C. For simplicity, the affect of multiple factors can be represented as a linear combination, as shown below:

$$\begin{matrix}SC ( p , C ) = d ( {a}_{h} , … , {a}_{q} ) \\ = f ( {d}_{1} ( {a}_{h 1} , … , {a}_{q 1} ) … {d}_{n} ( {a}_{hn} , … , {a}_{qn} ) \\ = {\sum }_{l} {k}_{l} d ( {a}_{hl} , … , {a}_{ql} ) ( e . g . )\end{matrix} \qquad ( 10 )$$

Thus, different attributes (aᵢⱼ) and distance functions (dᵢ) may represent user preferences and constraints about trusted organizations (e.g., lower cost for users working in the same company), reputation information (i.e., previous experiences), and existing social networks (e.g., people in a social network can be grouped with respect to the group proximity, so that social cost may be lower for sharing a ride with close friends).

The optimization module 118 may include the rideshare plan optimizer 310. The rideshare plan optimizer 310 may seek to identify the rideshare plan for a group of agents S that offers the highest combined value. In other words, the rideshare plan optimizer 310 may treat this optimization problem as a search problem over the universe of rideshare plans C(S) available for S, in which the search dimensions of C(S) are the set of possible commute chains, set of possible stop locations for the passenger agents, trip start times and potential routings between stop points.

Thus, the rideshare plan optimizer 310 may perform one or more geospatial searches over the feasible paths that satisfy the constraints of a rideshare plan for S. Given the start/end locations of the assigned driver, the rideshare plan optimizer 310 may compute updated routes by adding potential passenger stop points as waypoints and performing A* search. In at least one embodiment, the set of potential passenger stop points may be selected from a radius around the initial stop points of the passenger agent. Additionally, the magnitude of the radius may be limited by the maximum distance that the passenger agent is willing to diverge from the initial stop location to facilitate a more efficient rideshare. The rideshare plan optimizer 310 may also search for the start time of the rideshare plan that minimizes the total cost.

In this way, the rideshare plan optimizer 310 may select the plan C*(S) that offers the maximum total value to agent set S from among all possible plans C(S). The rideshare optimizer 312 may provide C*(S) to the rideshare group optimizer 312 as follows:

C*(S)=argmax_{c}_{ⱼ}_{∈C(S)}V(Cⱼ) (11)

The rideshare group optimizer 312 of the optimization module 118 may group the agents in the ABC system to produce the highest cumulative value for the ABC system. In various embodiments, given a set of agents P in the ABC system, the rideshare group optimizer 312 may find the set of subset of P that covers all agents in P by offering the highest, or the substantially highest cumulative value.

For example, a set of agents, P={p_{1,} . . . ,pₙ} may be willing to collaborate in an ABC system. In such a scenario, k may represent the capacity of a single vehicle, thus the maximum size of a collaborative rideshare group. A set cover for SCᵢ={Sₕ, . . . ,Sₘ} for agent set P may be a set of subsets of P, such that all subsets Sⱼ; |Sⱼ|≦k, ∪ₛ_{_{j∈SC}}_{ᵢ} Sⱼ=P, and for any Sⱼ, Sₖ ∈ SCᵢ Sⱼ∩Sₖ=Ø. Thus, a set cover SCᵢ in the ABC system may represent a collection of rideshare groups, and the best possible rideshare plans of the rideshare groups that cover all agents in the ABC system without exceeding the capacity of any transportation vehicle. SC(P)={SC_{1,} . . . ,SCᵣ} is defined to be the universe of all set covers for set of agents P.

The rideshare group optimizer 312 may use a valuation function, V(Sⱼ), which corresponds to the value generated by the best possible rideshare plan for bringing agents Sⱼ together. Accordingly, the value of a set cover SCᵢ, which is also a collective rideshare plan for P, may be expressed as:

$$\begin{matrix}V ( {S}_{j} ) = \{ \begin{matrix}0 & \vert {S}_{j} \vert \leq 1 \\ V ( {C}^{*} ( {S}_{j} ) ) & otherwise\end{matrix} & ( 12 ) \\ V ( {SC}_{i} ) = {\sum }_{{S}_{j} ∈ {SC}_{i}} V ( {S}_{j} ) & ( 13 )\end{matrix}$$

Based on these functions, the rideshare group optimizer 312 may implement an approximate, greedy set-cover algorithm to generate rideshare groups. In this way, the rideshare group optimizer 312 may ensure that no rideshare group is worse off because of participation in the ABC system 100. The rideshare group optimizer 312 may generate single-item subsets as well as rideshare groups in the set-cover optimization, thus selects individual (initial) trips for some of the agents rather than assigning them into carpools should no beneficial rideshare plan be available. Accordingly, any rideshare group generated by the rideshare optimizer 312 and the rideshare group optimizer 312 offers non-negative cumulative utility to the agents. However, in at least some embodiments, ensuring non-negative utility does not guarantee individual rationality or fairness between agents in the ABC system. The system may incur additional costs to the assigned driver agent for a group while generating benefit for the other passenger agents.

The ABC system 100 may implement scheduled or dynamic optimization to optimize commute plans for agents. According, the various modules described above may have dynamic architectures that handle commute requests on the fly, thus may provide agents flexibility to add, update or remove commute requests. The dynamic system may utilize an online myopic optimization to assign an upcoming commute request either as a passenger or a driver to a carpool, or as an individual commute if there are no beneficial carpools available. The carpool plans may get updated dynamically as more commute requests are introduced to the system.

The ABC system 100 may be used for models of transportation in which vehicles are considered to be shared resources that are allocated according to dynamic needs of agents. In these embodiments, the optimization module 118 may include transportation models that may introduce different levels of constraints to the ABC optimization, thus producing varying levels of efficiencies. In one of the models, every shared vehicle driven during morning commute needs to be driven back in the evening commute, but not necessarily by the same driver. Thus, this model may relax the constraint of the traditional scheduled model by allowing both passenger and driver sets to change between morning and evening commutes, but maintaining the shared vehicle set constant between morning and evening commutes. In at least one other embodiment, a more relaxed model may also allow vehicle sets to change between morning and evening commutes. This more relaxed model may function as an upper bound on the rideshare plans that can be provided by the ridesharing optimization, as this model assumes an unlimited supply of shared vehicles and thus minimizes the set of constraints on the ABC optimization.

Based on the generated rideshare plan for each of the rideshare groups, the optimization module 118 may provide individualized carpool information to the agents. For example, the ABC system 100 may provide carpool information such as carpool pickup locations, carpool dates and times, descriptions of carpool vehicles, etc.

The VCG payment module 120 may distribute VCG-based payments among the agents to promote truthful behavior, to ensure fairness and the ultimate sustainability of the ABC system, while maximizing total value of the collaboration. Thus, the VCG payment module 120 may calculate the amount of VCG payment (e.g., money) that each passenger agent in a carpool should pay into the overall ABC system to compensate each driver agent for the time and costs incurred by the driver agents in transporting the passenger agents.

Accordingly, ρᵢ, that is, agent pᵢ's VCG payment to the ABC system, may be calculated as below, given that V*₋ᵢ represents the collaborative of the collection of rideshare plans (SC*) to all agents except pᵢ, and (V₋ᵢ)* represents the value of the collection of rideshare plans when pᵢ is excluded from the ABC system:

ρᵢ=(V₋ᵢ)*−V*₋ᵢ (12)

Thus, if the carpool policy calculated by the optimization module 118 is optimal, the payment mechanism of the VCG payment module 120 may be considered to be efficient. In other words, the output of the VCG payment module 120 may be considered to maximize social value and ensure individual-rationality (all agents have positive utility by participating, and truth-telling is a dominant strategy). Furthermore, the VCG payment module 120 generally does not overburden the agents by inquiring about the utility of each potential rideshare assignment. Instead, valuations may be generated based on the preferences acquired by the user modeling module 116.

In various embodiments, the VCG payment module 120 may be configured based on the assumption that removing one agent from a carpool group does not affect the rideshare allocation of the agents outside the group. Thus, the VCG payment module 120 may calculate local VCG-based payments, which computes VCG payment of agent pᵢ only among the agents that share the same carpool as pᵢ. Accordingly, payment calculations by the VCG payment module 120 may become more efficient, as carpool optimizations for payment calculations are done over a small subset of all agents.

In at least some embodiments, the VCG payment module 120 may incorporate a threshold-based mechanism that enforces budget-balance as a hard constraint on payment calculations. Such a threshold-based mechanism may ensure that no deficits are incurred by the VCG-based ABC system (e.g., the ABC system paying driver agents more than the system collects from passenger agents).

Accordingly, the VCG payment module 120 may use a threshold rule to eliminate deficit. For example, in instances where V* is the cumulative value of rideshare plans, and where Δ_{vick,i} represents the non-negative portion of VCG payments (i.e., Vickery discount):

Δ_{vick,i}=V*−(V₋ᵢ)* (13)

For some parameter C≧0, the VCG payment module 120 may define threshold discounts Δ_{vicki,i}^{t}, and redefine payments ρᵢ^{t} based on Δ_{vicki,i}^{t}. Thus, the VCG payment module 120 may calculate threshold parameter C with linear programming based on local VCG-based payments and Δ_{vick,i} values:

Δ_{vicki,i}^{t}=max(0,Δ_{vick,i}−C) (14)

ρᵢ^{t}=vᵢ(SC*)−Δ_{vicki,i}^{t} (15)

With the use of a threshold-based mechanism, the VCG payment module 120 may eliminate the deficit for a range of time and fuel cost values of the ABC system without negatively influencing the individual rationality and the efficiency of the ABC system.

The output module 314 may provide the agents that participate in the ABC system with dynamic carpool information, as generated by the optimization module 118. In various embodiments, the carpool information may include carpool pickup locations, carpool dates and times, descriptions of carpool vehicles, agent roles (passenger or driver), etc.

The output module 314 may also enable the VCG payment module 120 to achieve budget balance with the ABC system 100. In various embodiments, the pay output module 314 may interface with a transaction system to collect payment or provide incentives to the various agents. For example, but not as a limitation, the output module 314 may cause the transaction system to send a bill, debit a savings account, credit card account, or payroll of a benefited agent for the amount of the payment equal to the benefit received. Conversely, the output module 314 may cause the transaction system to credit or otherwise provide payment to the agents that incurred costs through their participation in the ABC system.

The user interface module 316 may interact with a user via a user interface (not shown). The user interface may include a data output device such as a display, and one or more data input devices. The data input devices may include, but are not limited to, combinations of one or more of keypads, keyboards, mouse devices, touch screens, microphones, speech recognition packages, and any other suitable devices or other electronic/software selection methods.

The user interface module 316 may enable a user to manage the ABC system 100 that is implemented on the computing device 102. In various embodiments, the user interface user module 318 may enable a user to view information on the one or more active and scheduled carpools (e.g., carpool routes, participating agents, waiting list of carpool participants, payment debited from and/or credited to agents, etc.). The user module 318 may further enable the user other statistic emission related to the carpools, such as estimated reduction in CO₂ emissions, estimated reduction in the number of trips/miles driven, and other data.

The data storage module 318 may be configured to store data in a portion of memory 304 (e.g., a database). In various embodiments, the data storage module 318 may be configured to store data generated by the various modules of the computing device 102. For example, but not as a limitation, the data storage module 318 may store the agent preferences received by the input module 306 and processed by the user modeling module 116, the rideshare plans generated by the optimization module 118, and the VCG payment information produced by the VCG payment module 120. The data storage module 318 may also be configured to store any additional data derived, such as statistical data.

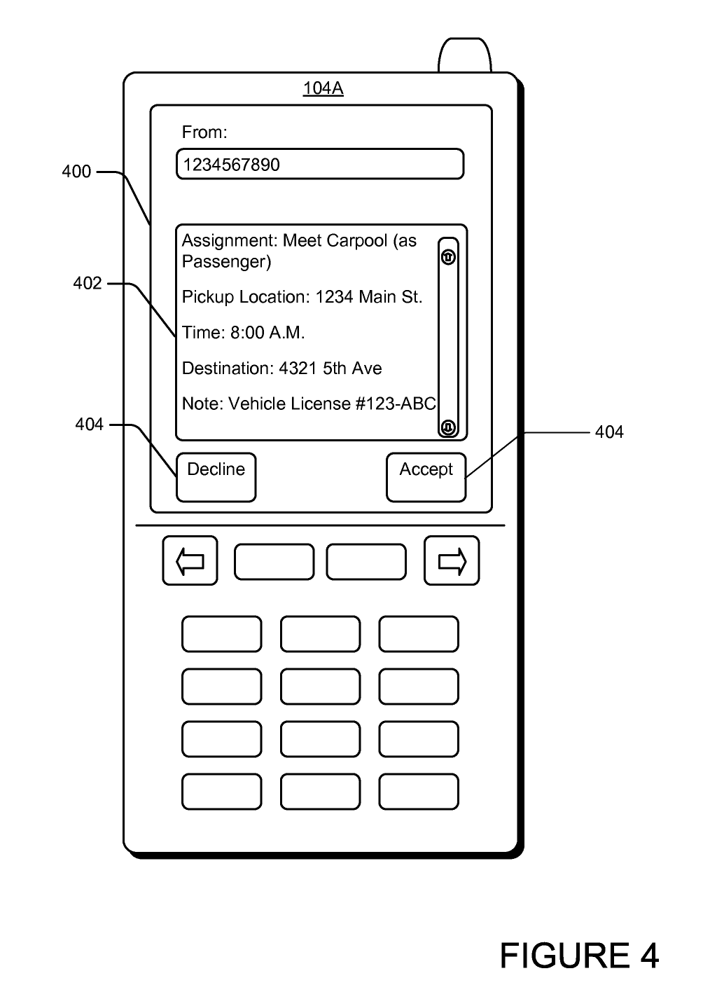

FIG. 4 illustrates exemplary carpool information that is presented on a display 400 of an exemplary client device, such as client device 104(A), in accordance with various embodiments. As shown, the display 400 may display the carpool information, as generated by the optimization module 118 and provided by the output module 314. In various embodiments, the carpool information may include carpool pickup locations, carpool dates and times, descriptions of carpool vehicles, agent roles (passenger or driver), etc. In various embodiments, the display 400 may further display an “accept” option 404 that enables an agent to accept a rideshare plan, or display a “decline” option 406 that enables an agent to decline the rideshare plan.

In various embodiments, the selection of an agent with regards to the options 404 and 406 may be communicated to the computing device 102 (FIG. 1) of the ABC system 100 via the input module 208 (FIG. 2). Based on the selection, the ABC system 100 may activate its various modules to adjust one or rideshare plans accordingly (e.g., recalculate one or more rideshare plans, assign the agent to a different rideshare plan, etc.).

### Exemplary Process

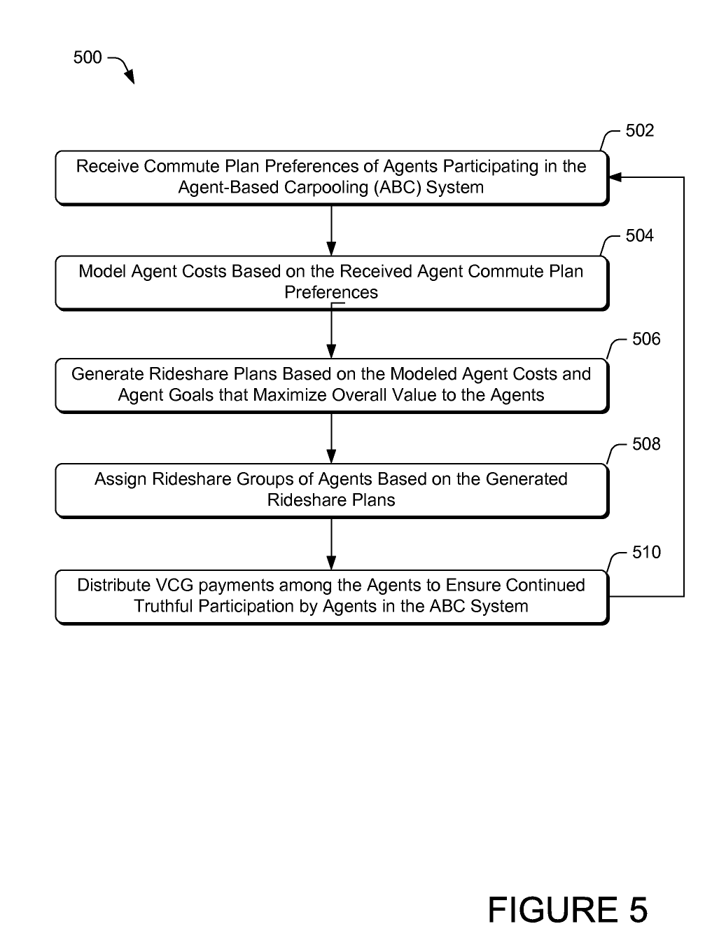

FIG. 5 illustrates a flow diagram showing an exemplary process that facilitates an agent-based carpooling (ABC) system employs a Vickrey-Clarke-Groves (VCG)-based payment mechanism, in accordance with various embodiments. The exemplary process 500 in FIG. 5 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to the exemplary computing device 102 of FIGS. 1 and 2, although it may be implemented in other system architectures.

At block 502, the agent-based carpooling (ABC) system 100 may receive commute plan preferences from agents participating in the system. In various embodiments, the participating agents may provide the agent preferences via client devices, such as the client devices 104(A-C). The agent preferences may include information such as agent identification, origin location, destination location, time of trips, preferences regarding a return trip, etc.

At block 504, the ABC system 100 may model agent costs based on the received agent commute plan preferences. In various embodiments, the ABC system 100 may model agent-specific costs for driving, delaying a trip, diverting from an ideal route to pick up or drop off other agents, and changing stop points for each of the participating agents.

During the modeling, the ABC system 100 may employ a probabilistic time-cost model to account for the cost of time for each agent. The probabilistic time-cost model may account for time costs as influenced by factors such as agents' commitments and appointments as an agent's willingness to rideshare may depend on the agent's day-to-day schedule. For example, an agent may be willing to wait and pick up other agents on the way when the cost of time is low (e.g., no meeting scheduled), but not on a day when time cost is high (e.g., meeting scheduled).

Moreover, the ABC system 100 may also take into account psychosocial costs when modeling agent costs. For example, the ABC system 100 may estimate the cost to an agent from traveling with one or more agents based on an established reputation, and/or on social or organizational relationships (e.g., social relationships may be reflected in graph distances in a social network). At block 506, the ABC system 100 may generate one or more collaborative rideshare plans based on the modeled agent costs and agent goals of each participating agent. The collaborative rideshare plans may be generated based on the individual desired commute preferences so that the overall value of the ABC system 100 to the agent is maximized. Each of the rideshare plans may include routes, stops and timing information.

In order to take into account inconvenience of at least some of the agents due to participation in the system, the ABC system 100 may use such an inconvenience model to combine the input from the modeling component 116 with traffic predictive services and daily contexts (e.g., daily events and conditions that may affect traffic) to construct a cognitive inconvenience cost model for each agent. Additionally, the ABC system 100 may perform geospatial search over the feasible paths to create rideshare plans with minimized inconvenience costs to each of the agents.

At block 508, the ABC system 100 may assign rideshare groups of agents based on the rideshare plans to produce the highest cumulative value for the system. In various embodiments, the rideshare groups may be assigned to implement the best possible rideshare plans without exceeding the capacity of any transport vehicle. In some embodiments, the ABC system 100 may assign the rideshare groups using an approximate, greedy set-cover algorithm so that no rideshare group is worse off, or experience negative utility, by its participation in the ABC system 100. The ABC system 100 may provide the rideshare plans in the form of individualized carpool information to the agents. For example, the ABC system 100 may provide carpool information such as carpool pickup locations, carpool dates and times, descriptions of carpool vehicles, agent roles (passenger or driver), etc. In some embodiments, an agent's refusal to participate in a particular rideshare plan may cause the ABC system 100 to modify one or more rideshare plans (e.g., recalculate one or more rideshare plans, assign the agent to a different rideshare plan, etc.).

At block 510, the ABC system 100 may employ a VCG-based payment mechanism to distribute payments among the agents to promote truthful behavior, to ensure fairness and the ultimate sustainability of the ABC system, while maximizing total value of the collaboration. For example, the ABC system 100 may calculate the amount of VCG payment (e.g., money) that each passenger agent in a carpool should pay into the overall ABC system to compensate each driver agent for the time and costs incurred by the driver agents in transporting the passenger agents. In some embodiments, the ABC system 100 may use a threshold-based mechanism to ensure that no deficits are incurred by the ABC system 100 (e.g., the ABC system paying driver agents more than the system collects from passenger agents). Subsequent to block 510, the process 500 may loop back to block 502, where the process 500 may be repeated.

It will be appreciated that the process 500 may be implemented dynamically. In other words, the blocks in the process 500 may be re-implemented as agents add, update or remove commute requests, so that the most updated collaborative rideshare plans may be generated to produce the highest cumulative value for the ABC system 100.

### Exemplary Computing Environment

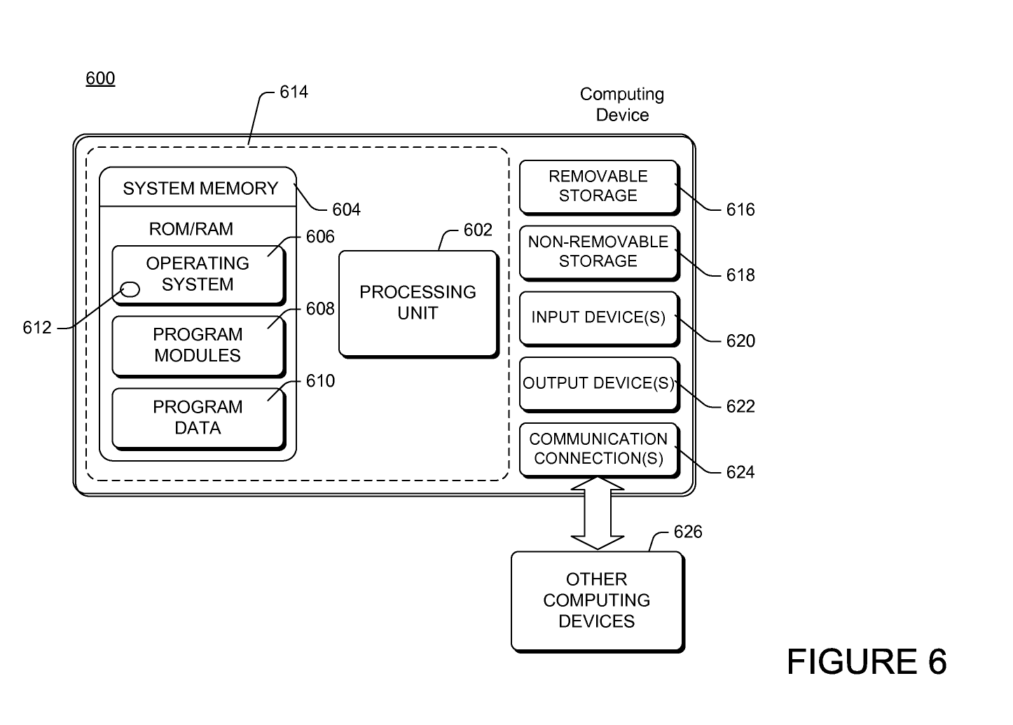

FIG. 6 illustrates a representative computing system 600 that is used to implement an agent-based carpooling (ABC) system that employs a VCG-based payment mechanism. The computing device 102, as described in FIG. 1, may be implemented using the computing system 600. However, it will be readily appreciated that the techniques and mechanisms may be implemented in other computing devices, systems, and environments. The computing system 600 shown in FIG. 6 is only one example of a computing device and is not intended to suggest any limitation as to the scope of use or functionality of the computer and network architectures. Neither should the computing system 600 be interpreted as having any dependency or requirement relating to any one or combination of components illustrated in the example computing device.

In a very basic configuration, Computing system 600 typically includes at least one processing unit 602 and system memory 604. Depending on the exact configuration and type of computing device, system memory 604 may be volatile (such as RAM), non-volatile (such as ROM, flash memory, etc.) or some combination of the two. System memory 604 typically includes an operating system 606, one or more program modules 608, and may include program data 610. The operating system 606 includes a component-based framework 612 that supports components (including properties and events), objects, inheritance, polymorphism, reflection, and provides an object-oriented component-based application programming interface (API), such as, but by no means limited to, that of the .NET™ Framework manufactured by the Microsoft Corporation, Redmond, Wash. The device 600 is of a very basic configuration demarcated by a dashed line 614. Again, a terminal may have fewer components but will interact with a computing device that may have such a basic configuration.

Computing system 600 may have additional features or functionality. For example, computing system 600 may also include additional data storage devices (removable and/or non-removable) such as, for example, magnetic disks, optical disks, or tape. Such additional storage is illustrated in FIG. 6 by removable storage 616 and non-removable storage 618. Computer storage media may include volatile and nonvolatile, removable and non-removable media implemented in any method or technology for storage of information, such as computer readable instructions, data structures, program modules, or other data. System memory 604, removable storage 616 and non-removable storage 618 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing system 600. Any such computer storage media may be part of device 600. Computing system 600 may also have input device(s) 620 such as keyboard, mouse, pen, voice input device, touch input device, etc. Output device(s) 622 such as a display, speakers, printer, etc. may also be included. These devices are well known in the art and are not discussed at length here.

Computing system 600 may also contain communication connections 624 that allow the device to communicate with other computing devices 626, such as over a network. These networks may include wired networks as well as wireless networks. Communication connections 624 are some examples of communication media. Communication media may typically be embodied by computer readable instructions, data structures, program modules, etc.

It is appreciated that the illustrated computing system 600 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The agent-based carpooling system may enable participants, or agents, to set up rideshares (carpools), thereby making use of unused seats in vehicles to reduce CO₂ emission, reduce fuel consumption, relieve traffic congestion, as well as produce other benefits. The agent-based carpooling system may adapt to varied and dynamic preferences of self-interested agents and provide compelling and fair incentives. Thus, the agent-based mechanism may provide efficient solution to collaborative ridesharing that creates personalized ridesharing plans while reducing the cumulative cost of transportation.

Further, the optimization and optimization mechanisms described herein in the context of the agent-based carpooling may be generally applied for any situation that calls for the generation of collaborative plans for sets of individual contributors, or agents, with individual goals and preferences, and who might otherwise execute plans as individuals.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A rideshare system, comprising:
an input component to receive commute plan preferences of agents via one or more client devices;
a modeling component to model agent costs based on the received commute plan preferences;
an optimizer component to generate one or more rideshare plans based on the modeled agent costs and group one or more agents into each rideshare plan;
an output component to provide the one or more generated rideshare plans to the agents via the one or more client devices for implementation; and
a Vickrey-Clarke-Groves (VCG)-based payment component to distribute payments among the agents to compensate at least one driver agent for participation in one of the generated rideshare plans.

2. The system of claim 1, wherein the VCG-based payment component is to distribute payments among the agents by collecting payment from at least one passenger agent.

3. The system of claim 1, wherein the modeling component includes a probabilistic time-cost model to account for a time cost of each agent.

4. The system of claim 1, wherein the modeling component includes a probabilistic time-cost model that uses time of day, day of week, and appointments of agents to account for a time cost of each agent.

5. The system of claim 1, wherein the modeling component is to model agent costs based on agent-specific costs for at least one of cost of driving, cost of delaying a trip, cost of driving, cost of diverting from an ideal route pick up or drop one or more agents, or cost of changing stop points for one or more agents.

6. The system of claim 1, wherein the optimizer component further includes:
a rideshare plan optimizer to generate the one or more rideshare plans based on the model agent costs to maximize the overall value of the rideshare system to the agents; and
a rideshare group optimizer to assign rideshare group of agents based on the rideshare plans to produce the highest cumulative value for the rideshare system.

7. The system of claim 1, wherein the optimizer component further includes a rideshare plan optimizer component that uses traffic predictions and daily contexts to estimate inconvenience cost for each of the agents, and perform a geospatial search over the paths of the rideshare plans to minimize inconvenience cost to each of the agents.

8. The system of claim 1, wherein the optimizer component further includes a rideshare group optimizer that uses an approximate, greedy-set algorithm to ensure that the one or more agents grouped into each rideshare plan does not experience negative utility due to participation in the rideshare system.

9. The system of claim 1, wherein the VCG-based payment component includes a threshold-based mechanism to ensure that no deficits are incurred by the rideshare system.

10. The system of claim 1, wherein the commute plan preferences of each agent includes one or more of agent identification, origin location, destination location, time of trip, and return trip preference.

11. The system of claim 1, wherein each of the provided rideshare plans includes at least one of a carpool pick location, carpool date and time, description of carpool vehicle for each of the one or more agents.

12. A method, comprising:
receiving commute plan preferences of agents at a computing device from one or more client devices;
modeling agent costs based on the received commute plan preferences and agent-specific costs of each agent at the computing device;
generating one or more rideshare plans at the computing device based on the modeled agent costs and group one or more agents into each rideshare plan;
providing the one or more generated rideshare plans from the computing device to the agents via the one or more client devices for implementation;
computing Vickrey-Clarke-Groves (VCG)-based payments to compensate at least one driver agent for participation in one of the generated rideshare plans at the computing device; and
collecting VCG payments from at least one passenger agent at the computing device for benefit derived from participation in one of the generated rideshare plans.

13. The method of claim 12, wherein the modeling includes a probabilistic time-cost model that use time of day, day of week, and appointments of agents to account for a time cost of each agent.

14. The method of claim 12, wherein the agent-specific costs for each agent includes least one of cost of driving, cost of delaying a trip, cost of driving, cost of diverting from an ideal route pick up or drop one or more agents, cost of changing stop points for one or more agents, or psychosocial cost of traveling with the one or more agents, the psychosocial cost being based at least on established reputations of the one or more agents, social relationships with the one or more agents, or organizational relationships with the one or more agents.

15. The method of claim 12, wherein the generating includes:
generating the one or more rideshare plans based on the model agent costs to maximize the overall value of a rideshare system to the agents; and
assigning rideshare group of agents based on the rideshare plans to produce the highest cumulative value for the rideshare system.

16. The method of claim 12, wherein the generating includes using traffic predictions and daily contexts to estimate inconvenience cost for each of the agents, and perform a geospatial search over the paths of the rideshare plans to minimize inconvenience cost to each of the agents.

17. The method of claim 12, wherein the generating includes using an approximate, greedy-set algorithm to ensure that the one or more agents grouped into each rideshare plan does not experience negative utility due to participation in the rideshare system.

18. The method of claim 12, wherein the receiving includes receiving commute plan preferences of each agent that includes one or more of agent identification, origin location, destination location, time of trip, and return trip preference.

19. The method of claim 12, wherein the providing includes providing at least one of a carpool pick location, carpool date and time, description of carpool vehicle for each of the one or more agents.

20. A computer readable medium storing computer-executable instructions that, when executed, cause one or more processors to perform acts comprising:
receiving individual plan preferences of agents into a computing device of a collaboration system from one or more client devices;
modeling agent costs based on the received individual plan preferences and agent-specific costs of each agent at the computing device;
generating one or more collaborative plans based on the modeled agent costs to maximize the overall value of the collaboration system to the agents at the computing device;
assigning agents to collaborative groups based on the collaborative plans to produce the highest cumulative value for the collaboration system at the computing device;
providing the one or more generated collaborative plans from the computing device to the agents via the one or more client devices for implementation;
computing Vickrey-Clarke-Groves (VCG)-based payments to compensate at least one agent for participation in one of the generated collaborative plans at the computing device; and
distributing VCG payments among the agents to compensate at least one agent for participation in one of the generated collaborative plans.

21. The computer readable medium of claim 20, wherein the generating includes using an approximate, greedy-set algorithm to ensure that the one or more agents grouped into each collaborative plan does not experience negative utility due to participation in the collaborative system.

22. The computer readable medium of claim 20, wherein the distributing includes distributing VCG payments among the agents by collecting payment from at least one first agent that receives a benefit via participation in the collaboration plan and distributing the payment to at least one second agent that incurs a loss via participation in the collaboration plan.
